(19) United States
(12) Patent Application Publication
(10) Pub. No.: US 2019/0373296 A1
(43) Pub. Date: Dec. 5, 2019

(54) CONTENT STREAMING SYSTEM AND METHOD

(71) Applicant: LABS.FM (PTY) LTD, Cape Town (ZA)

(72) Inventor: Richard John OAKLEY, Cape Town (ZA)

(73) Assignee: LABS.FM (PTY) LTD, Cape Town (ZA)

(21) Appl. No.: 16/478,376

(22) PCT Filed: Dec. 12, 2017
(86) PCT No.: PCT/IB2017/057837

§ 371 Date: Jul. 16, 2019

(30) Foreign Application Priority Data
Jan. 17, 2017 (ZA) 2017/00356

(51) Int. Cl. H04N 21/2387; H04N 21/845; H04N 21/45; H04N 21/24

(52) U.S. Cl. CPC H04N 21/2387; H04N 21/2401; H04N 21/4532; H04N 21/8456

(57) ABSTRACT

A content streaming system and method are provided. A method at a client-side user device includes receiving a first content stream from a first content source via a communication network. The first content stream includes a sequence of content segments and the user device outputs the first content stream for consumption by a user. Responsive to receiving a change instruction associated with a user preference, output of the first content stream is paused and output of a replacement content item is commenced. The replacement content item is obtained from a second content source. Output of the first content stream is automatically recommenced. In one embodiment, the replacement content item has a limited duration and output of the first content stream is automatically recommenced upon completion of output of the replacement content item.

### CROSS-REFERENCE TO RELATED APPLICATIONS

This application claims priority from South African provisional patent application number 2017/00356 filed on 17 Jan. 2017, which is incorporated by reference herein.

### FIELD OF THE INVENTION

This invention relates to a system and method for content steaming.

### BACKGROUND TO THE INVENTION

Content, for example, in the form of programme material such as audio or video programmes or media may be delivered to user devices via broadcast signal, internet streaming and the like.

In the case of radio or television broadcasting, a radio or television programme (or other data for that matter) is typically modulated on a carrier frequency, transmitted as a radio signal via e.g. satellite, and demodulated or decoded at a client-side user device such as a radio or television receiver. The broadcast signal, be it pre-recorded or live, is typically transmitted as a continuous signal in real-time, often interspersed with advertisement segments. The signal is typically pre-constructed at the broadcast end. Some decoders at the user-end are equipped with memory for storing the broadcast signal and thus allowing the signal to be paused, rewound and forwarded. A user can navigate through the pre-constructed signal in his or her own time (e.g. by forwarding) and so speed through parts of the signal, e.g. the advertisement segments. The user may not be able to wholly skip selected parts of the signal.

In the case of internet streaming, a programme signal is typically broken up and encoded into data packets (forming a data stream) that are transmitted asynchronously via the Internet to an end user device such as a client-side computer web browser, each data packet carrying the same destination address of the end user device. The data packets are “collected” at the end user device as they arrive over time. Upon successful receipt of a meaningful number of packets, the packets may be “stitched” together and the programme signal re-constructed for output to the user. An increase in Internet speed has enabled what is perceived to be live streaming. As is the case with pre-recorded programme material, a so-called live stream is also packaged and transmitted asynchronously.

It is not uncommon for the providers of programme material to generate revenue through advertisements. Typically, the greater the number of programme material consumers, the greater the revenue the programme material provider can generate from these advertisements. Consumer retention may therefore be important to these programme material providers.

At present, there is no adequate technological solution which sufficiently addresses problems such as these and there is accordingly scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a computer-implemented method for content streaming, the method being conducted at a client-side user device and comprising: receiving a first content stream from a first content source via a communication network, the first content stream including a sequence of content segments; outputting the first content stream for consumption by a user; responsive to receiving a change instruction associated with a user preference, pausing output of the first content stream and commencing output of a replacement content item, the replacement content item having been obtained from a second content source; and automatically recommencing output of the first content stream.

Further features provide for the first content source to be an internet content streaming source and for the method to include buffering of the first content stream.

A further feature provides for buffering of the first content stream to include buffering of the first content stream during at least a portion of output of the replacement content item.

Further features provide for the change instruction to be received during output of a particular content segment of the first content stream and for recommencing output of the first content stream to recommence output at the beginning of a next content segment of the first content stream.

Still further features provide for the method to include obtaining a timestamp at which output of the first content stream is to be recommenced and receiving timestamp correction information.

Even further features provide for obtaining the timestamp to include receiving the timestamp from a remote server and applying the timestamp correction information to translate the received timestamp into a device domain timestamp.

Further features provide for the method to include identifying the replacement content item and for identifying the replacement content item to include using one or more of a user profile, a machine learning component and a segment categorization associated with the paused content segment.

Still further features provide for the method to include accessing the replacement content item from the second content source, for the second content source to be local to or remote from the client-side user device.

A yet further feature provides for the replacement content item to include one or more content segments of a second content stream.

A further feature provides for receiving of the change instruction to include receiving an auto-generated change instruction or a change instruction input by a user of the client-side user device.

A still further feature provides for the replacement content item to have a limited duration and for output of the first content stream to be automatically recommenced upon completion of output of the replacement content item.

In accordance with a further aspect of the invention there is provided a computer-implemented method for content streaming, the method being conducted at a remote server and comprising: receiving a change instruction notification from a client-side user device, the change instruction notification having been transmitted from the client-side user device via a communication network in response to the client-side user device receiving a change instruction associated with a user preference during output of a first content stream, wherein output of the first content stream is paused at the client-side user device and output of a replacement content item is commenced in response to receiving the change instruction; identifying, from a sequence of content segments included in the first content stream, a content segment in which the change instruction was received; identifying a timestamp associated with a transition point in the first content stream at which the identified content segment transitions to a next content segment in the sequence of content segments; and transmitting a recommencement instruction to the client-side user device configured to instruct the client-side user device as to a point in time in the first content stream at which output of the first content stream is to be recommenced.

In accordance with a further aspect of the invention there is provided a system for content streaming, the system including a client-side user device having a memory for storing computer-readable program code and a processor for executing the computer-readable program code, the client-side user device comprising: a content stream receiving component for receiving a first content stream from a first content source via a communication network, the first content stream including a sequence of content segments; a content output component for outputting the first content stream for consumption by a user; a content output control component for, responsive to receiving a change instruction associated with a user preference, pausing output of the first content stream and commencing output of a replacement content item via the content output component, the replacement content item having been obtained from a second content source; and a recommencement component for causing the content output control component automatically to recommence output of the first content stream via the content output component.

In accordance with an even further aspect of the invention there is provided a system for content streaming, the system including a remote server having a memory for storing computer-readable program code and a processor for executing the computer-readable program code, the remote server comprising: a notification receiving component for receiving a change instruction notification from a client-side user device, the change instruction notification having been transmitted from the client-side user device via a communication network in response to the client-side user device receiving a change instruction associated with a user preference during output of a first content stream, wherein output of the first content stream is paused at the client-side user device and output of a replacement content item is commenced in response to receiving the change instruction; a content segment identifying component for identifying, from a sequence of content segments included in the first content stream, a content segment in which the change instruction was received; a timestamp identifying component for identifying a timestamp associated with a transition point in the first content stream at which the identified content segment transitions to a next content segment in the sequence of content segments; and, an instruction transmitting component for transmitting a recommencement instruction to the client-side user device configured to instruct the client-side user device as to a point in time in the first content stream at which output of the first content stream is to be recommenced.

In accordance with a further aspect of the invention there is provided a computer program product for content streaming comprising a computer-readable medium having stored computer-readable program code for performing the steps of: receiving a first content stream from a first content source via a communication network, the first content stream including a sequence of content segments; outputting the first content stream for consumption by a user; responsive to receiving a change instruction associated with a user preference, pausing output of the first content stream and commencing output of a replacement content item, the replacement content item having been obtained from a second content source; and automatically recommencing output of the first content stream.

In accordance with a yet further aspect of the invention there is provided a computer program product for content streaming comprising a computer-readable medium having stored computer-readable program code for performing the steps of: receiving a change instruction notification from a client-side user device, the change instruction notification having been transmitted from the client-side user device via a communication network in response to the client-side user device receiving a change instruction associated with a user preference during output of a first content stream, wherein output of the first content stream is paused at the client-side user device and output of a replacement content item is commenced in response to receiving the change instruction; identifying, from a sequence of content segments included in the first content stream, a content segment in which the change instruction was received; identifying a timestamp associated with a transition point in the first content stream at which the identified content segment transitions to a next content segment in the sequence of content segments; and, transmitting a recommencement instruction to the client-side user device configured to instruct the client-side user device as to a point in time in the first content stream at which output of the first content stream is to be recommenced.

Further features provide for the computer-readable medium to be a non-transitory computer-readable medium and for the computer-readable program code to be executable by a processing circuit.

In accordance with a further aspect of the invention there is provided a linear programme streaming method for delivering a programme to a user device of an end-user, the method being conducted at a client-side user device, including the steps of: receiving a linear programme stream at the client-side user device; receiving one or more replacement content segments; buffering the linear programme stream; segmenting the linear programme stream into an earlier first linear segment, and a later second linear segment; inserting the one or more replacement content segments between the first and second linear programme segments thereby constructing a delayed programme stream as a sequence of the earlier first linear segment, replacement content segment, and later second linear segment; playing back the delayed programme stream at the client-side user device, for operative skipping of the one or more replacement content segments in their entirety.

The terms “linear programme” and “linear segment” may refer to audio or video streams such as podcast streams, movies, music, or the like, which is streamed via satellite networks, mobile telephone networks, landline data networks, cable networks, or the like. The data segments need not be live broadcast streams, but refers to data streams representing audio/video. The terms “live programme stream” or “live segment” will be used in the remainder of the specification, but should be interpreted to refer to any type of linear data stream representing audio/video content.

The replacement content segment may include, but is not limited to, any one or more of an interactive menu, a replacement programme such as an advertisement, a pre-recorded audio or video programme, a multimedia programme, and another live programme stream of the like.

To this end, the interactive menu may include one or more navigation commands for selecting one or more replacement content segments, and playback controls for seeking, pausing, rewinding, forwarding and skipping of the replacement content segments.

Constructing of the delayed programme stream may include the user's selecting of the replacement content segments to be inserted into the delayed programme stream.

Further features provide for the constructing of the delayed programme stream to include the user's switching between the live programme stream and the replacement content segments; and for the playing back of the delayed programme stream to include the users navigating of the delayed stream via the playback controls.

The method may include retrieving the live programme stream from a live content server located remote from the end user device. The method may include retrieving the one or more replacement content segments from a server located remote from the end user device, such as a remote replacement content server or a cloud-based server. The method may include, after retrieving the replacement content segments from the server, storing the replacement content segments in a local or remote software library of the end user device for convenient access by the user when constructing the delayed programme stream in use.

Receiving of the live programme stream may include transmitting a request for the live programme stream to a server-side Application Programming Interface (API) of the live content server and receiving a response from the API of the live content server. Likewise, receiving of the one or more replacement content segments may include transmitting a request for the replacement content segments to an API of the remote replacement content server, and receiving a response from the API of the remote replacement content server.

To this end, the transmitting of the request and receiving of the response from the server-side API may include receiving at least one remote timestamp of the live programme stream. Likewise, transmitting of the request and receiving of the response from the API of the remote replacement content server may include receiving at least one remote timestamp of the replacement content segments.

Segmenting of the live programme stream may include marking the buffered live programme stream with at least one local timestamp.

Yet further features provide for the constructing of the delayed programme stream to include comparing the remote timestamps of the live programme stream and the replacement content segments with the local timestamp of the buffered live programme stream to facilitate a seemingly live viewing experience.

According to another aspect of the invention, there is provided a linear programme streaming system for performing the linear programme streaming method as hereinbefore described, the system including: an end-user device configured to receive a linear programme stream from a linear content server and one or more replacement content segments from a replacement content server, the end-user device being located remote from the linear content server and replacement content server, the end-user device being operable to buffer the linear programme stream, segment the linear programme stream into an earlier first linear segment and a later second segment, insert the replacement content segment between the first and second linear programming segments thereby constructing a delayed programme stream, and playing back the delayed programme stream at the end-user device.

The system may include a software application resident on the end-user device, the software application being operable to construct the delayed programme stream from any one or more of the replacement content segments, interactive menu and navigation commands, and play back the delayed programme stream.

The software application may be configured for receiving the live programme stream from the live programme server by receiving and transmitting to the live programme server a request and a response. Likewise, the application may be configured for receiving the replacement content segments from the replacement content server by receiving and transmitting to the replacement content server a request and a response.

The software application may be configured to exchange at least one remote timestamp of the live programme stream and the replacement content segments between the live programme server, replacement content server and the end-user device. Likewise, the application may be configured to exchange at least one local timestamp of delayed programme stream between the live programme server, replacement content server and the end-user device. To this end, the software application may be configured to construct the delayed programme signal by processing the remote time stamp and the local time stamp to enable a seemingly live broadcast or streaming experience.

The end-user device may include, but is not limited to a PC, and a mobile device such as a mobile phone, smart phone and tablet computer. Conveniently, any of the servers may be cloud-based.

Embodiments of the invention will now be described, by way of example only, with reference to the accompanying drawings.

### BRIEF DESCRIPTION OF THE DRAWINGS

In the drawings:

FIG. 1 is a schematic diagram which illustrates an exemplary content streaming system according to aspects of the disclosure;

FIG. 2 is a flow diagram which illustrates an exemplary content streaming method according to aspects of the disclosure;

FIG. 3 is a swim-lane flow diagram which illustrates an example method for determining and providing timestamp correction information to a user device according to aspects of the disclosure;

FIG. 4 is a swim-lane flow diagram which illustrates an exemplary method for automatically recommencing output of a content steam according to aspects of the disclosure;

FIG. 5 is a block diagram which illustrates exemplary components which may be provided by a content streaming system;

FIG. 6 is a schematic diagram which illustrates an exemplary live programme streaming system which, in use, performs a live streaming method of delivering a programme to a user according to aspects of this disclosure;

FIG. 7 is a schematic diagram which illustrates constructing of a delayed programme stream in accordance with aspects of this disclosure; and

FIG. 8 illustrates an example of a computing device in which various aspects of the disclosure may be implemented.

### DETAILED DESCRIPTION WITH REFERENCE TO THE DRAWINGS

Aspects of the present disclosure relate to content streaming systems and methods in which a user can operatively skip a particular content segment of a content stream being output by a user device. A replacement content item is dynamically retrieved and output in place of the skipped content segment. Upon completion of the replacement content item, the user is returned to the content stream. In some implementations, the user is returned to the content stream in a position which immediately follows the content segment which was skipped.

In one exemplary scenario, the user may be listening to an internet radio content stream and may wish to skip a particular song which is not to the user's preference. The user may input a change instruction which causes the user device to replace output of the particular song which is not to the user's taste and replace it with one that is. After completion of the replacement song, the user is returned to the internet radio content stream at a point which immediately follows the song that was skipped. In this manner, the user can skip content segments which are not to the user's liking without the internet radio station losing out on the user's audience in the longer run.

As used herein, the term “content item” should be interpreted to include a content file, recording or other fixation of finite length which is configured for output or playback by a user device. Exemplary content items include: songs, sound or video clips (e.g. advertisements), videos (such as movies or television programmes) and the like.

As used herein, the term “content segment” should be interpreted to include a related collection of data and/or signals of finite length which is transmitted from or broadcast by a content source to user devices via a communication network. Exemplary content segments include content items, “live” audio and/or visual transmissions (such as a news or weather broadcasts, sports events, a presenter or DJ's commentary, etc.) and the like.

As used herein, the term “content stream” should be interpreted to include the continuous (at least over a specific period) and sequential transmission or broadcast of content segments by a content source to user devices via a communication network. A content stream may comprise a number of sequential content segments, some of which may be content items and others of which may be “live” content segments.

Streaming content may refer to multimedia that is constantly received by and presented to an end-user while being delivered by a provider. The verb “to stream” may refer to the process of delivering or obtaining content in this manner; the term may refer to the delivery method of the medium, rather than the medium itself, and may be an alternative to file downloading, a process in which the end-user obtains the entire file for the content before watching or listening to it.

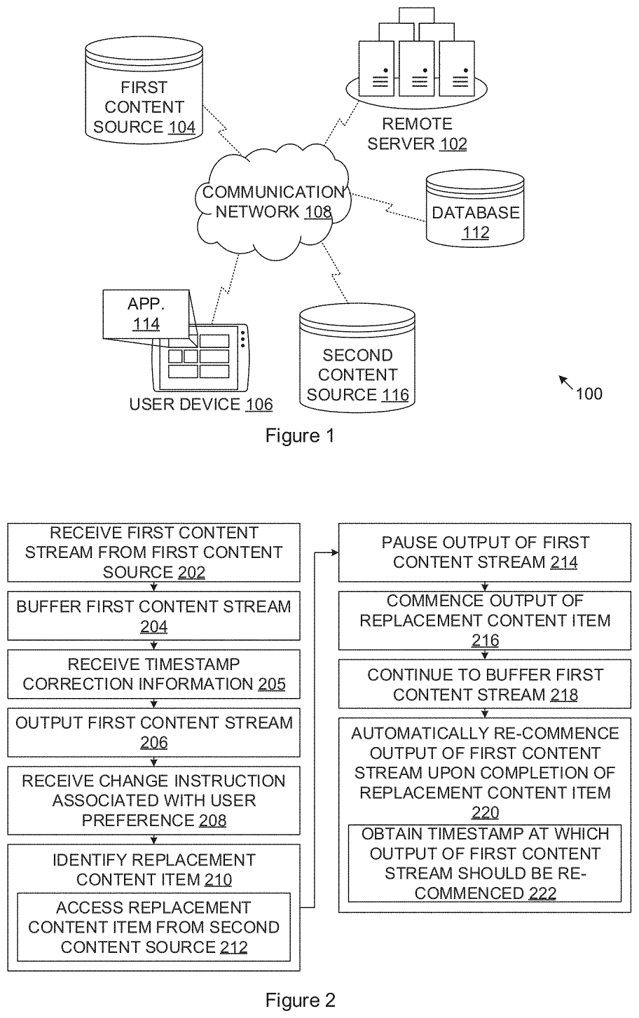

FIG. 1 is a schematic diagram which illustrates an exemplary content streaming system (100). The system (100) may include a remote server (102), a first content source (104) and a client-side user device (106).

The remote server (102), first content source (104) and user device (106) may communicate with each other via a suitable communication network (108). The communication network (108) may include the Internet and its associated infrastructure and, in some implementations, other communication networks such as terrestrial- or satellite-based broadcast networks, the public switched telephone network (PTSN) and the like. For example, in some implementations, the first content source (104) may broadcast a content stream to the remote server (102) and/or user device (106) via a suitable terrestrial- or satellite-based broadcast network. In other implementations, the first content source (104) may be an internet streaming content source and may transmit a content stream to the remote server (102) and/or user device (106) via the Internet.

The remote server (102) may be any suitable computing device configured to perform a server role. The remote server (102) may be maintained, operated and/or under the control of a service provider. The remote server (102) may have access to a database (112) in and from which records, data and/or information may be stored and accessed. The database (112) may store a user profile which is uniquely associated with a user of the user device (106). The user profile may store data relating to the user's content preferences which may be updated or adapted by the user, remote server (102) and/or a suitable machine learning component as time goes by.

The remote server (102) may be configured to determine delays associated with timing information included in segment metadata. The delays may be positive or negative and may be introduced by a number of factors, such as: network latency, lost data packets, delays introduced by the configuration of a broadcast automation system or the like. Delays may differ from one content service to another and different techniques may be used for different content services (and in some cases depending on the level of system access). The remote server (102) may be configured to calculate timestamp correction information (e.g. based on the delays) associated with content streams and provide the timestamp correction information to the user device (106).

The first content source (104) may be provided by a content service and may be configured to transmit or broadcast a first content stream to the remote server (102) and/or user device (106) via the communication network (108). The first content source (104) may also be configured to transmit metadata relating to the first content stream to the remote server (102) and/or user device (106) via the communication network (108). The segment metadata may for example include, for each content segment of the first content stream, one or more of a segment identifier, segment timing information and a segment categorization. The segment timing information may include one or more of: start time, end time and duration of the content segment. The segment characterization may include a name of content included in the segment, a genre associated with the segment or the like. The first content source (104) may include a broadcast automation system which may be configured to output the segment metadata.

The client-side user device (106) may be any suitable electronic device capable of communicating on the communication network (108). The user-device may for example be in the form of a mobile phone (e.g. a smart phone), a tablet computer, a portable digital assistant, a wearable computing device, a smart appliance, a gaming console, a digital media player, a laptop or desktop computer, a vehicle-based entertainment system (e.g. radio or head unit, etc.) or the like. In some implementations, the user device may be provided by a mobile device such as a mobile phone coupled to a vehicle-based entertainment system using a suitable standard (e.g. CARPLAY by APPLE, INC.). The user device (106) may have a software application (114) resident therein and installed thereon which may be configured to provide functionality described herein. The user device (106) may be configured to receive and output audio streams and/or content items. The user device (106) may further receive or otherwise determine timestamp correction information for use in switching between content streams or items, as will be described in greater detail below.

The system may further include a second content source (116). The second content source (116) may be local to or remote from the user device (106) and, for example, may include a music or video library which is stored in the user device (106) or which is remotely accessible by the user device (106). The second content source (116) may be configured to output one or more content items via the user device (106) upon demand. The second content source (116) may be configured to output content items associated with a user preference (e.g. based on information stored in the user profile). In some implementations, the second content source (116) may be provided by a content service and may be configured to transmit or broadcast a second content stream and optionally associated metadata to the remote server (102) and/or user device (106) via the communication network (108).

The above-described system (100) may implement a content streaming method. In particular, the system (100) may implement a method in which the user device (106), consuming the first content stream, can be caused to pause output of the first content stream and commence output of a replacement content item or segment, which may be accessed from the second content source (116). The replacement content item or segment may be associated with a user preference. Upon completion of the replacement content item or segment, the user device (106) may recommence output of the first content stream at a predefined position within the first content stream.

An exemplary content streaming method is illustrated in the flow diagram of FIG. 2. The method may be conducted at the client-side user device (106).

The method may include receiving (202) a first content stream from the first content source (104) via the communication network (108). The first content stream may include sequence of content segments. The first content stream may be configured for output or playback by the user device (106). In an exemplary internet streaming scenario (e.g. in the case of internet radio), the first content stream may be received in a series of packets transmitted over the communication network (108) and configured for playback via the user device (106). In aspects described herein, content streams may be assembled in a container “bitstream” such as MP4, FLV, WebM, ASF or ISMA. The bitstream may be delivered from a streaming server of the first media source (104) to the user device (106) using a transport protocol, such as RTMP or RTP. In some implementations, technologies enabling adaptive bitrate streaming over HTTP may be utilised. In some implementations, a streaming transport protocol may be used to send video from an event venue to a “cloud” transcoding service and CDN, which may then use HTTP-based transport protocols to distribute the video to individual user devices. Some implementations may use HTTP live streaming (HLS). The user device (106) may interact with the first media source (104) using a suitable control protocol, such as MMS, RTSP or the like.

The method may include buffering (204) the first content stream.

The method may include receiving (205) timestamp correction information. The timestamp correction information may be received from the remote server (102) and may enable correction of timestamps received from the server in, for example, recommencement instruction messages relating to a point in the first content stream at which output should be recommenced.

The method may include outputting (206) the first content stream for consumption by a user of the user device (106). Output may be via suitable input/output (I/O) devices associated with the user device (106) (e.g. display, touch-sensitive display, speakers and the like).

At some stage during output of the first content stream, the method may receive (208) a change instruction associated with a user preference. The change instruction may be received during output of a particular content segment of the first content stream. The change instruction may be auto-generated or may be received by way of user input into the user device (106). For example, the change instruction may be received by way of user input instructing skipping of the particular content segment being output at that point in time.

In cases where the change instruction is auto-generated, the method may include determining suitability of the particular (or a next) content segment and, if the suitability of the content segment is low, the change instruction may be generated in relation to the particular (or next) content segment. Determining the suitability may use one or more of the user profile, a machine learning component and the segment categorization associated with the particular (or next) segment.

Auto-generation of the change instruction may be as simple as, for example in the case of a news broadcast, comparing a spoken language of the user as recorded in the user profile with a language specified in a segment categorization associated with the news broadcast. In other cases, more complex algorithms may be employed to auto-generate the change instruction (e.g. based on the user's music preference as learned by the machine learning component over time).

In any event, the change notification is in some way associated with a preference of the user in that it represents a desire (or expected desire) of the user to skip the particular (or next) content segment of the first content stream and instead to output a content item or segment. For example, the particular content segment may be a song which is not the user's taste, an advertisement that the user is not interested in hearing, a news broadcast which is not in the user's first language, etc.

The method may include identifying (210) a replacement content item or segment. In some implementations, identifying the replacement content item may use one or more of the user profile, the machine learning component and the segment categorization associated with the particular content segment (i.e. the content segment being skipped). In other implementations, the replacement content item may be randomly identified. Identifying (210) the replacement content item may include accessing (212) the replacement content item or segment from a second content source (116). As mentioned, the second content source (116) may be local to or remote from the user device (106). In some cases, accessing the replacement content segment may include accessing a content segment of a second content stream. The replacement content item may be a song retrieved from the second content source (116), a news broadcast which is in the user's first language, an advertisement which is relevant to the user and which the user may enjoy, etc.

The method may include pausing (214) output of the first content stream and commencing (216) output of the replacement content item or segment for consumption by the user. Output may be via suitable input/output (I/O) devices associated with the user device (e.g. display, touch-sensitive display, speakers and the like).

The method may include continuing (218) to buffer the first content stream during output of the replacement content item or segment.

The method may include automatically recommencing output (220) of the first content stream. Recommencement may occur automatically upon the occurrence of a predetermined event. For example, in some implementations recommencement may occur automatically upon completion of the replacement content item. Recommencing output of the first content stream may recommence output of the first content stream at the beginning of a content segment which immediately follows the particular content segment during the output of which the change instruction was received. Output may be recommenced “automatically” in the sense that no user intervention or user input is required. Output of the first content stream may thus be recommenced in a seamless manner. In some cases, automatically recommencing output (220) of the first content stream may include receiving a recommencement instruction from the remote server (102) which instructs the communication device to recommence output of the first content stream and which may include timestamp information relating to the point in the first content stream at which output should be recommenced. In other implementations, recommencement may occur automatically upon expiry of the content segment that was paused or skipped (i.e. the content segment in which the change instruction was received). The user may for example want to hear the recommenced first content stream in real time and not delayed to accommodate the completion of the replacement content item.

Automatically recommencing output (220) of the first content stream may include obtaining (222) a timestamp of the first content stream at which output of the first content stream should be recommenced. The timestamp at which output of the first content stream is to be recommenced may be obtained (222) in a variety of ways. In some implementations, the timestamp may be received from the remote server (102) in a recommencement instruction message and the user device (106) may apply timestamp correction to account for any delays and to accurately recommence output of the first content stream at the correct point in the stream (e.g. at the beginning of a content segment which immediately follows the content segment which was skipped).

In other implementations, the user device may obtain the time stamp at which output of the first content stream is to be commenced by determining the timestamp itself. For example, the method may include receiving metadata relating to the first content stream. The segment metadata may be received from the first content source (104) or from the remote server (102) via the communication network (108). In some implementations, the segment metadata may be received from the first content source (104) and may form a part of the content stream. In other implementations, the segment metadata may be received from the remote sever (102). In some implementations, metadata may be received from the first content source (104) and the remote server (102).

The method may also include receiving timestamp correction information. The timestamp correction information may form a part of the segment metadata and receiving the timestamp correction information may include extracting the timestamp correction information from the segment metadata. In other implementations, the timestamp correction information may be received separately from or instead of the segment metadata. The timestamp correction information may be received from the first content source (104) or remote server (102) via the communication network (108).

The method may include determining transition points in the buffered first content stream. Transition points may be points in the first content stream at which one content segment transitions to the next content segment. Determining the transition points may use one or both of the segment metadata and timestamp correction information.

The method may include monitoring the first content stream (or the buffer of the first content stream) for the transition point which follows the particular content segment what has been skipped. The method may include flagging the transition point which follows the particular content segment what has been skipped. Buffer data relating to content segments which precede the particular content segment in which the change instruction was received may be discarded.

The method may accordingly facilitate skipping of particular content segments of a content stream, outputting a replacement content item or segment and then returning to the content stream upon completion of the replacement content item or segment. The content stream may be returned to automatically upon completion of the replacement content item or segment.

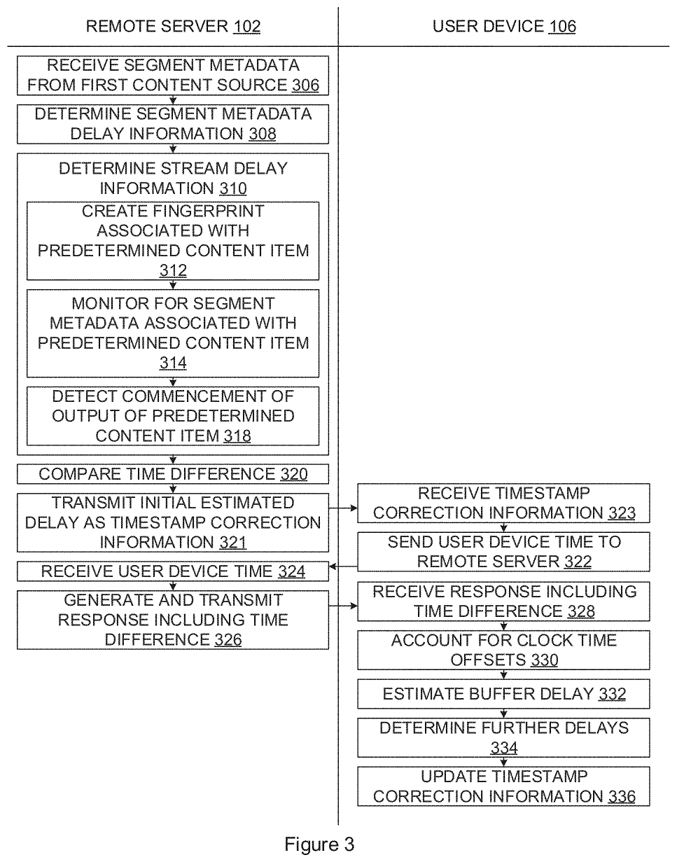

FIG. 3 is a swim-lane flow diagram which illustrates an example method for determining and providing timestamp correction information to the user device (106) according to aspects of the disclosure. In the Figure, respective swim-lanes delineate operations, procedures, steps, etc. performed by respective entities or devices. Aspects of the method described below may be implemented in conjunction with the method described above with reference to FIG. 2.

The first content source (104) may transmit or broadcast segment metadata associated with the first content stream. The segment metadata may be transmitted via the communication network (108) and may either form a part of the first content stream or may be transmitted separately from (but in association with) the first content stream. In some implementations, the segment metadata may be provided by the broadcast automation system of the content service. The segment metadata may include, for each content segment of the first content stream, one or more of a segment identifier; segment timing information and a segment categorization. In some implementations, the segment metadata is transmitted directly to the remote server (102).

The remote server (102) may receive (306) the segment metadata. The segment metadata may be received from the first content source (104) via the communication network (108). In some implementations, the remote server (102) may monitor the first content source (104) for the segment metadata while in other embodiments the segment metadata may be transmitted directly to the remote server.

As mentioned, one source of delay may be the broadcast automation system, which may send segment metadata updates either early or late. For example, instead of sending the timing information of a segment as its output commences, the broadcast automation system may transmit the segment metadata only (e.g.) 30 seconds after the fact. This 30 second delay would therefore need to be accounted for and applied against timestamp information.

The remote server (102) may determine (308) segment metadata delay information relating to any delays associated with transmission or broadcast of the segment metadata by the first content source (104).

A content stream broadcast or transmitted by way of a communication network is rarely truly “live” in the sense that delays are incurred between the time at which the content stream is broadcast or transmitted from the content source and the time at which the content stream is output at the communication device. One source of such transmission delays may be network latency (e.g. how much time it takes for a packet of data to get from one designated point to another). For this reason, while a content segment may be ‘broadcast’ at a particular timestamp, the stream may delayed by an amount of time, and therefore the content segment may only be heard at that delayed time.

The remote server (102) may determine (310) stream delay information relating to any delays associated with broadcast and/or receipt of the first content stream. This may include using content (e.g. audio) fingerprinting. Determining (310) stream delay information may include creating (312) a fingerprint or other suitable digital identifier associated with a predetermined content item (e.g. a popular music track) and monitoring (314) segment metadata received from the first content source (104) for segment metadata associated with the predetermined content item. The remote server (102) may record the first content stream and detect (318), using the fingerprint, when output of the predetermined content item in the first content stream actually commenced. The remote server (102) may compare (320) the time difference between timing information of the segment metadata and the point in time at which output of the predetermined content segment commenced to determine stream delay information. This time difference may be added as an additional delay to apply against future item timestamps. It should be appreciated that these steps may be repeated periodically for continual updating of the transmission delay.

The remote server (102) may accordingly arrive at an initial estimated delay associated with the first content stream. The initial estimated delay may be an accurate representation of when a particular content item or segment will actually commence in a particular stream (e.g. the first content stream). The initial estimated delay may be transmitted (321) to the user device (106) as timestamp correction information (optionally together with other timestamp correction information) for use thereat in accounting for delays associated with timestamps.

The user device (106) may receive (323) the timestamp correction information including the initial estimated delay. This initial estimated delay may be based on the assumption that the user device (106) consumes the first content stream at exactly the same time as it was broadcast. However, this is not necessarily the case as the user device (106) may not be in sync with the broadcast of the content stream.

Consequently, additional delays may need to be applied to convert server timestamps (i.e. based on the initial estimated delay) to user device timestamps, so that they can be compared against one another. Such delays may have a number of sources. One possible source of delay or offset may be that the actual clock times between the user device (106) and server (102) are different.

Clock time difference may be determined by the user device (106) sending (322) its own time to the remote server (102). The remote server (102) may receive (324) the user device time, determine any difference between the user device time and server time (by comparing the user device time to the server time) and generate and transmit (326) a response including the difference between the received user device time and the remote server time. The user device (106) may receive (328) the response including the time difference and use the time difference to account (330) for any clock time offsets (e.g. by adding the time difference to a cumulative delay factor).

As mentioned above, the user device (106) may create a buffer of the content stream data when (or prior to) commencing output thereof. Creation of this buffer may result in the user device (106) being slightly behind the first content source (104) and may accordingly be a further source of delay. The user device (106) may estimate (332) this buffer delay. In some implementations (e.g. in the case of a constant bitrate stream), estimating (332) the buffer delay may include measuring the buffer size at the point the stream starts playing and dividing this size by a bitrate associated with the first content stream. In other implementations, other techniques may be used. The remote server (102) may transmit control messages to the user device (106) to enable this functionality. The control messages may be configured to instruct the user device (106) as to how to control the buffer (e.g. how much to store, where in the buffer to resume playback etc.).

The user device (106) may determine (334) further delays by, for example, measuring the amount of time for which the first content stream has been output by the user device (e.g. how far into the first content stream the user device is). Such further delays can be incurred for a variety of reasons, e.g. by way of disconnects or network issues, manual pauses, etc. and these can be accounted for by measuring only the playback time.

The user device (106) may update (336) timestamp correction information based on the additional delay information, such as the further delays, buffer delays and clock offset delays. In this manner, timestamps received from the remote server (102) may be accurately compared with the user device timestamp (and vice versa). For example, if the remote server says an item plays at a particular timestamp (after applying any server-side delays), the user device may be able to determine what the difference is between that and their current timestamp, so that functionality (such as the ability to skip) can be determined on this basis. In addition, if the remote server (102) instructs the user device (106) to move to a particular timestamp in the content stream, the user device may be able to calculate how far they need to move forward or back in the buffer to resume playback at exactly that point.

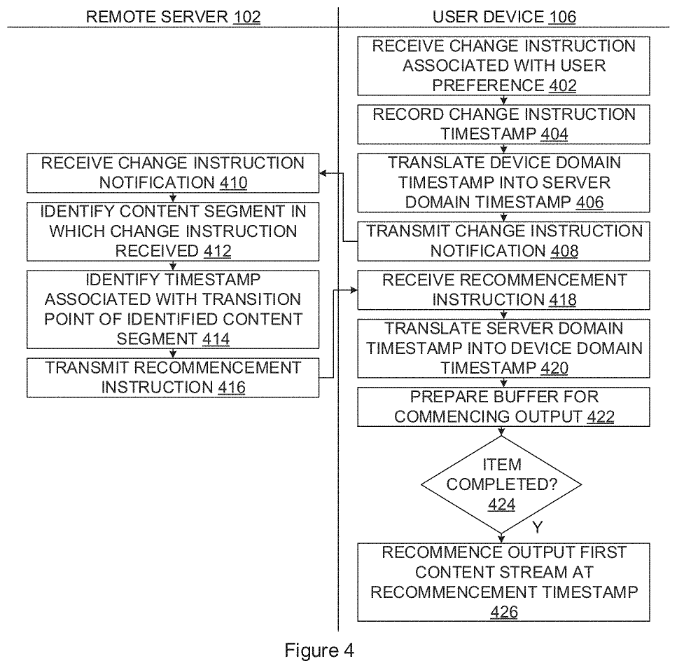

An exemplary method for automatically recommencing output of the first content steam is illustrated in the swim-lane flow diagram of FIG. 4. Respective swim-lanes delineate operations, procedures, steps, etc. performed by respective entities or devices. Aspects of the method described below may be implemented in conjunction with the methods described above with reference to FIGS. 2 and 3.

The user device (106) may receive (402) a change instruction associated with a user preference. As mentioned above, the change instruction may be auto-generated or may be received by way of user input.

The user device (106) may record (404) a timestamp corresponding to the time at which the change instruction is received. The timestamp may be tied to output of the first content stream. That is, the timestamp may indicate a time in the first content stream at which the change instruction was received. The timestamp may be based on the user device time and hence may be a “device domain” timestamp.

The user device (106) may translate (406) the device domain timestamp into a server domain timestamp using timestamp correction information. This may, for example, include adding or subtracting a delay associated with the timestamp correction information to the device domain timestamp to arrive at the server domain timestamp.

The user device (106) may transmit (408) a change instruction notification to the remote server (102). The change instruction notification may include the timestamp to the remote server (102). In some implementations, the change instruction notification may include the server domain timestamp while in other implementations the change instruction notification may include the device domain timestamp as well as timestamp correction information for use at the remote server (102) in generating a server domain timestamp.

The remote server (102) may receive (410) the change instruction notification from the user device (106). In some implementations, the change instruction notification may include a device domain timestamp and timestamp correction information and the remote server (102) may translate the device domain timestamp into a server domain timestamp using the timestamp correction information. In other implementations, the change instruction notification may include a server domain timestamp.

The remote server (102) may identify the content segment of the first content stream that was skipped by receipt of the change instruction. This may include using the timestamp included in the change instruction notification (or an adaptation thereof) to identify (412) the content segment of the first content stream in which the change instruction was received. This may include mapping the timestamp to a content segment of the first content stream. The remote server (102) may identify (414) a timestamp associated with a transition point associated with the identified content segment. The remote server (102) may for example ascertain a time within the first content stream at which the identified content segment comes to an end and/or at which a next content segment commences.

The remote server (102) may transmit (416) a recommencement instruction to the user device (106). The recommencement instruction may include the transition point timestamp. The transition point timestamp may for example be a time within the first content stream at which the content segment which was skipped by way of the change instruction comes to an end. The recommencement instruction may be configured to instruct the user device (106) as to a point in time at which output of the first content stream is to be recommenced. In some implementations, the remote server (102) may convert the recommencement timestamp into a device domain timestamp using timestamp correction information.

The user device (106) may receive (418) the recommencement instruction from the remote server (102). In some implementations, the recommencement instruction may include a server domain timestamp and the user device may translate (420) the server domain timestamp into a device domain timestamp using timestamp correction information. This may, for example, include adding or subtracting a delay associated with the timestamp correction information to the server domain timestamp to arrive at the device domain timestamp. In other implementations, the recommencement instruction may include a device domain timestamp.

As mentioned previously, the user device (106) may have continued to buffer the first content stream during output of the replacement item. The user device (106) may prepare (422) the buffer of the first content stream for commencing output of the first content stream at the recommencement timestamp. This may include only buffering data of the first content stream which relates to the next content segment.

Upon (424) completion of output of the replacement content item, the user device (106) may recommence output (426) of the first content stream at the recommencement timestamp. This may include recommencing output of the first content stream at a point in the first content stream at which the content segment immediately following the content segment which was skipped commences.

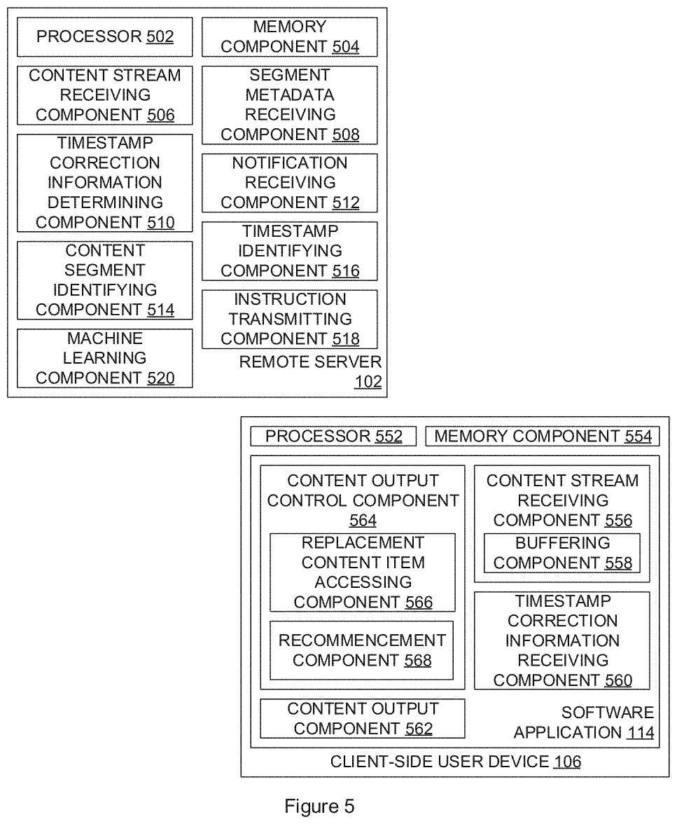

Various components may be provided for implementing the methods described above with reference to FIGS. 2 to 4. FIG. 5 is a block diagram which illustrates exemplary components which may be provided by a content streaming system including a remote server (102) and a client-side user device (106).

The remote server (102) may include a processor (502) for executing the functions of components described below, which may be provided by hardware or by software units executing on the remote server (102). The software units may be stored in a memory component (504) and instructions may be provided to the processor (502) to carry out the functionality of the described components. Software units arranged to manage and/or process data on behalf of the remote server (102) may be provided remotely, e.g. in a cloud-based architecture.

The remote server (102) may include a content stream receiving component (506) arranged to receive content streams from content sources (104, 116) via the communication network (108).

The remote server (102) may include a segment metadata receiving component (508) arranged to receive segment metadata associated with content segments of content streams. The segment metadata may be received from content sources (104, 116) via the communication network (108).

The remote server (102) may include a timestamp correction information determining component (510) arranged to determine timestamp correction information which may be usable in translating server domain timestamps into device domain timestamps, and vice versa. The timestamp correction information determining component (510) may include functionality configured to determine various delays associated with the content streams and/or segment metadata, clock time differences, etc. and to transmit timestamp correction information to the client-side user device (106) via the communication network (108).

The remote server (102) may include a notification receiving component (512) arranged to receive change instruction notification from the client-side user device (106). The change instruction notification may have been transmitted from the client-side user device (106) via the communication network (108) in response to the client-side user device receiving a change instruction associated with a user preference during output of a first content stream.

The remote server (102) may include a content segment identifying component (514) arranged to identify, from a sequence of content segments included in the first content stream, a content segment in which the change instruction was received.

The remote server (102) may include a timestamp identifying component (516) arranged to identify a timestamp associated with a transition point in the first content stream at which the identified content segment transitions to a next content segment in the sequence of content segments.

The remote server (102) may include an instruction transmitting component (518) arranged to transmit a recommencement instruction to the client-side user device (106). The recommencement instruction may be configured to instruct the client-side user device (106) as to a point in time in the first content stream at which output of the first content stream is to be recommenced once output of the replacement content item has been completed.

The remote server (102) may include a machine learning component (520) which may be arranged to learn behaviour, preferences, etc. associated with a user of the user device (106). The machine learning component may employ suitable machine learning algorithms and may have access to the database (112) in order to implement functionality described herein.

The client-side user device (106) may include a processor (552) for executing the functions of components described below, which may be provided by hardware or by software units executing on the client-side user device (106). The software units may be stored in a memory component (554) and instructions may be provided to the processor (552) to carry out the functionality of the described components. Software units arranged to manage and/or process data on behalf of the client-side user device (106) may be provided remotely, e.g. in the case of a cloud-computing architecture. Some or all of the components may be provided by a software application (114) downloadable onto and executable on the client-side user device (106).

The software application (114) may include a content stream receiving component (556) arranged to receive a first content stream from a first content source via the communication network (108). The first content stream may include a sequence of content segments. The content stream receiving component (556) may include a buffering component (558) arranged to buffer the first content stream. The buffering component (558) may buffer the first content stream during output of replacement content streams. In some implementations, the buffering component (558) may be controlled by the remote server (102).

The software application (114) may include a timestamp correction information receiving component (560) arranged to receive timestamp correction information from the remote server (102). The timestamp correction information receiving component (560) may be configured to determine clock offsets between device clock time and sever clock time, estimate buffer delays and update timestamp correction information received from the remote server (102).

The software application (114) may include a content output component (562) arranged to output the first content stream for consumption by a user. The content output component (562) may output content for consumption by the user via suitable input/output (I/O) devices associated with the user device (e.g. display, touch-sensitive display, speakers and the like).

The software application (114) may include a content output control component (564) arranged to control output of content via the content output component (562) and I/O devices. The content output control component (564) may be configured to receive a change instruction associated with a user preference, to pause output of the first content stream and commence output of a replacement content item via the content output component.

The content output control component (564) may include a replacement content item accessing component (566) arranged to access the replacement content item. The content item accessing component (566) may obtain the replacement content item from the second content source (116).

The content output control component (564) may include a recommencement component (568) arranged to cause the content output control component (564) to automatically recommence output of the first content stream via the content output component (562) and I/O devices upon completion of output of the replacement content item.

The recommencement component (568) may be arranged to interact with the remote server (102) to establish a timestamp corresponding to a time in the first content stream at which output thereof should be recommenced. The recommencement component (568) may be arranged to transmit a timestamp corresponding to a time in the first content stream at which the change instruction was received and to receive a recommencement instruction including a timestamp relating to a time in the first content stream at which output should be recommenced. The recommencement component (568) may also be configured to control the buffering component (558) to prepare the buffer for output of the first content stream at the particular time.

Aspects of the disclosure may provide a method of delivering advertisement segments as part of a live stream or live broadcast programme whilst imparting a user experience of real-time, live programme consumption, tailored to the user's preference.

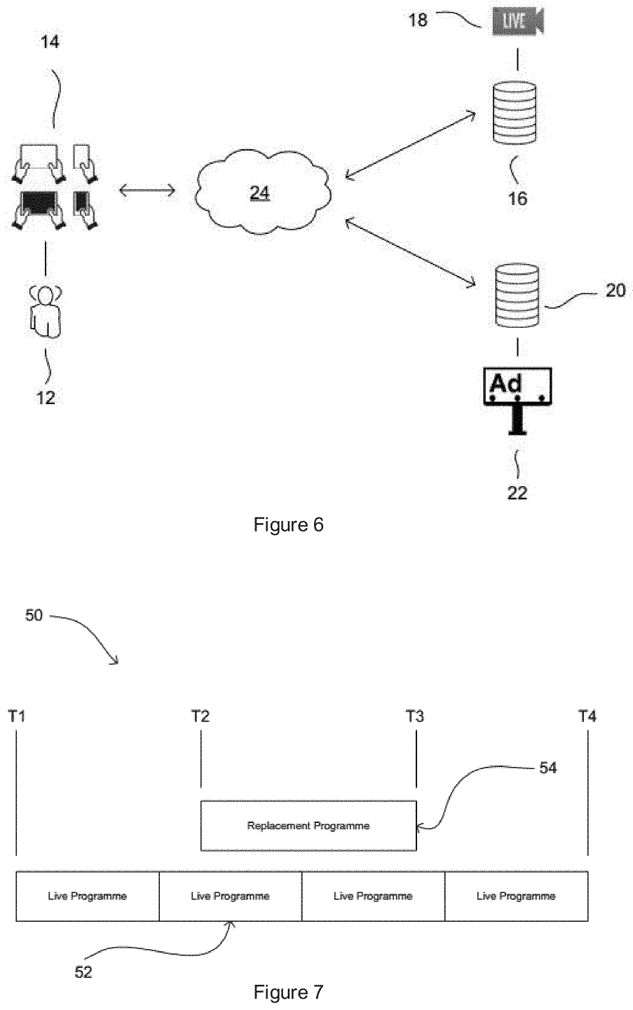

In FIG. 6 a live programme streaming system, in use, performs a live streaming method of delivering a programme to a user. The system comprises a live content server (16) that hosts a live programme stream (18), a replacement content server (20) that hosts one or more replacement content segments (22), and a device of an end-user (12) in the form of a mobile device (14).

At a first step, the client device (14) requests the live programme stream (18) from an API of the live content server (16) and a replacement content segment (22) from an API of the replacement content server (20). The live programme stream and the replacement content segment are transmitted to the mobile device (14) of the end-user (12) via the Internet (24).

At a second step and having received the live programme stream, the live programme stream (18) is buffered at the end-user device (14) to create a buffered live programme stream (52), in view of constructing a delayed programme stream for operative playback by the user (12).

In this embodiment, the replacement content segments include an interactive menu, and a pre-recorded advertisement segment. Further, the interactive menu includes navigation commands and playback controls for seeking, pausing, rewinding, forwarding and skipping of the replacement content segment, i.e. the advertisement segment.

Next, a delayed programme stream is constructed at the end-user device (14) by using the buffered live programme stream and replacement content segments (22) received from the replacement content server (20), as will become more apparent with reference to FIG. 7 hereunder.

FIG. 7 is a schematic diagram which illustrates constructing of a delayed programme stream in accordance with an example embodiment.

At a next step in the method, the buffered live programme stream (52) is segmented into an earlier, first live segment marked by timestamps T1 to T2, and a later, second live segment marked by timestamps T3 to T4. Next, the replacement content segment (54), i.e. the advertisement segment of T2 to T3, is inserted between the earlier first live segment and the later second live segment, thereby constructing the delayed programme stream as a linear sequence of the first live segment, advertisement segment and the second live segment (not shown here).

With the delayed programme stream having been constructed, the user (12) starts playback of the delayed stream via the playback control for viewing of the first live segment marked T1 to T2. At T2, the user (12) invokes the interactive menu, thereby pausing the buffered live programme stream (52). The advertisement segment T2 to T3 is presented to the user (12) via the interactive menu and the user is offered an opportunity to view the advertisement segment, or to skip the advertisement segment and advance to the second live segment at T3 to T4 in the buffered programme stream (52). After either viewing or skipping the advertisement segment, the user (12) returns to the second live segment T3 to T4. Advantageously, the user (12) continues viewing the live programme stream at the earlier take-off time T3, the second live segment having been delayed but appearing to the user as a continuation of the first live segment.

Aspects of the disclosure may accordingly provide a seemingly live viewing or listening experience through the combined use of client-side buffering, time stamping and playback of replacement content retrieved from a remote location.

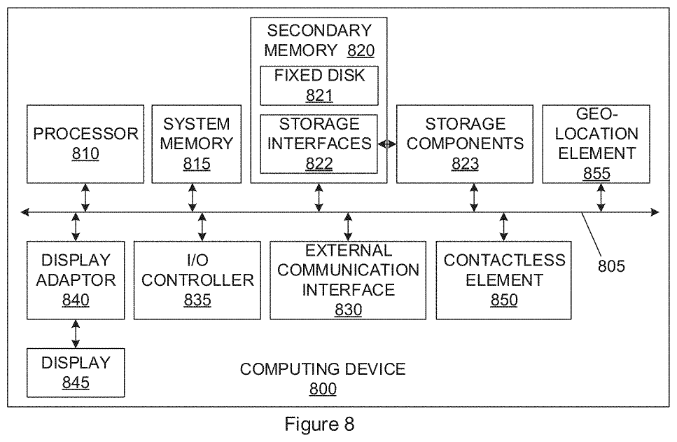

FIG. 8 illustrates an example of a computing device (800) in which various aspects of the disclosure may be implemented. The computing device (800) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (800) may be suitable for storing and executing computer program code. The various participants and elements in the previously described system diagrams may use any suitable number of subsystems or components of the computing device (800) to facilitate the functions described herein. The computing device (800) may include subsystems or components interconnected via a communication infrastructure (805) (for example, a communications bus, a network, etc.). The computing device (800) may include one or more processors (810) and at least one memory component in the form of computer-readable media. The one or more processors (810) may include one or more of: CPUs, graphical processing units (CPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (800) may be distributed over a number of physical locations (e.g. in a distributed, cluster or cloud-based computing configuration) and appropriate software units may be arranged to manage and/or process data on behalf of remote devices.

The memory components may include system memory (815), which may include read only memory (ROM) and random access memory (RAM). A basic input/output system (BIOS) may be stored in ROM. System software may be stored in the system memory (815) including operating system software. The memory components may also include secondary memory (820). The secondary memory (820) may include a fixed disk (821), such as a hard disk drive, and, optionally, one or more storage interfaces (822) for interfacing with storage components (823), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (800) may include an external communications interface (830) for operation of the computing device (800) in a networked environment enabling transfer of data between multiple computing devices (800) and/or the Internet. Data transferred via the external communications interface (830) may be in the form of signals, which may be electronic, electromagnetic, optical, radio, or other types of signal. The external communications interface (830) may enable communication of data between the computing device (800) and other computing devices including servers and external storage facilities. Web services may be accessible by and/or from the computing device (800) via the communications interface (830).

The external communications interface (830) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuity. The external communications interface (830) may include a subscriber identity module (SIM) in the form of an integrated circuit that stores an international mobile subscriber identity and the related key used to identify and authenticate a subscriber using the computing device (800). One or more subscriber identity modules may be removable from or embedded in the computing device (800).

The external communications interface (830) may further include a contactless element (850), which is typically implemented in the form of a semiconductor chip (or other data storage element) with an associated wireless transfer element, such as an antenna. The contactless element (850) may be associated with (e.g., embedded within) the computing device (800) and data or control instructions transmitted via a cellular network may be applied to the contactless element (850) by means of a contactless element interface (not shown). The contactless element interface may function to permit the exchange of data and/or control instructions between computing device circuitry (and hence the cellular network) and the contactless element (850). The contactless element (850) may be capable of transferring and receiving data using a near field communications capability (or near field communications medium) typically in accordance with a standardized protocol or data transfer mechanism (e.g., ISO 14443/NFC). Near field communications capability may include a short-range communications capability, such as radio-frequency identification (RFID), Bluetooth™, infra-red, or other data transfer capability that can be used to exchange data between the computing device (800) and an interrogation device. Thus, the computing device (800) may be capable of communicating and transferring data and/or control instructions via both a cellular network and near field communications capability.

The computer-readable media in the form of the various memory components may provide storage of computer-executable instructions, data structures, program modules, software units and other data. A computer program product may be provided by a computer-readable medium having stored computer-readable program code executable by the central processor (810). A computer program product may be provided by a non-transient computer-readable medium, or may be provided via a signal or other transient means via the communications interface (830).

Interconnection via the communication infrastructure (805) allows the one or more processors (810) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (800) either directly or via an I/O controller (835). One or more displays (845) (which may be touch-sensitive displays) may be coupled to or integrally formed with the computing device (800) via a display (845) or video adapter (840).

The computing device (800) may include a geographical location element (855) which is arranged to determine the geographical location of the computing device (800). The geographical location element (855) may for example be implemented by way of a global positioning system (GPS), or similar, receiver module. In some implementations the geographical location element (855) may implement an indoor positioning system, using for example communication channels such as cellular telephone or Wi-Fi™ networks and/or beacons (e.g. Bluetooth™ Low Energy (BLE) beacons, iBeacons™, etc.) to determine or approximate the geographical location of the computing device (800). In some implementations, the geographical location element (855) may implement inertial navigation to track and determine the geographical location of the communication device using an initial set point and inertial measurement data.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™ C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A computer-implemented content streaming method comprising, at a client-side user device:
receiving a first content stream from a first content source via a communication network, the first content stream including a sequence of content segments;
outputting the first content stream for consumption by a user;
responsive to receiving a change instruction associated with a user preference, pausing output of the first content stream and commencing output of a replacement content item, the replacement content item having been obtained from a second content source (116); and
automatically recommencing output of the first content stream.

2. The method as claimed in claim 1, wherein the first content source is an internet content streaming source, the method including buffering the first content stream.

3. The method as claimed in claim 2, wherein buffering the first content stream includes buffering the first content stream during at least a portion of output of the replacement content item.

4. The method as claimed in claim 1, wherein the change instruction is received during output of a particular content segment of the first content stream and wherein recommencing output the first content stream recommences output at the beginning of a next content segment of the first content stream.

5. The method as claimed in claim 1, including obtaining a timestamp at which output of the first content stream is to be recommenced.

6. The method as claimed in claim 5, including receiving timestamp correction information, and wherein obtaining the timestamp at which output of the first content stream is to be recommenced includes receiving the timestamp from a remote server and applying the timestamp correction information to translate the received timestamp into a device domain timestamp.

7. The method as claimed in claim 1, including identifying the replacement content item.

8. The method as claimed in claim 7, wherein identifying the replacement content item uses one or more of a user profile, a machine learning component and a segment categorization associated with the paused content segment.

9. The method as claimed in claim 1, including accessing the replacement content item from the second content source, wherein the second content source is local to or remote from the client-side user device.

10. The method as claimed in claim 1, wherein the replacement content item includes one or more content segments of a second content stream.

11. The method as claimed in claim 1, wherein receiving the change instruction receives an auto-generated change instruction or a change instruction input by a user of the client-side user device.

12. The method as claimed in claim 1, wherein the replacement content item has a limited duration and wherein output of the first content stream is automatically recommenced upon completion of output of the replacement content item.

13. A computer-implemented content streaming method comprising, at a remote server:
receiving a change instruction notification from a client-side user device, the change instruction notification having been transmitted from the client-side user device via a communication network in response to the client-side user device receiving a change instruction associated with a user preference during output of a first content stream, wherein output of the first content stream is paused at the client-side user device and output of a replacement content item is commenced in response to receiving the change instruction;
identifying from a sequence of content segments included in the first content stream, a content segment in which the change instruction was received;
identifying a timestamp associated with a transition point in the first content stream at which the identified content segment transitions to a next content segment in the sequence of content segments; and,
transmitting a recommencement instruction to the client-side user device configured to instruct the client-side user device as to a point in time in the first content stream at which output of the first content stream is to be recommenced.

14. A content streaming system including a client-side user device including a memory for storing computer-readable program code and a processor for executing the computer-readable program code, the client-side user device comprising:
a content stream receiving component for receiving a first content stream from a first content source via a communication network, the first content stream including a sequence of content segments;
a content output component for outputting the first content stream for consumption by a user;
a content output control component for, responsive to receiving a change instruction associated with a user preference, pausing output of the first content stream and commencing output of a replacement content item via the content output component the replacement content item having been obtained from a second content source; and
a recommencement component for causing the content output control component automatically to recommence output of the first content stream via the content output component.

15. The system as claimed in claim 14, including a remote server including a memory for storing computer-readable program code and a processor for executing the computer-readable program code, the remote server comprising:
a notification receiving component for receiving a change instruction notification from the client-side user device, the change instruction notification having been transmitted from the client-side user device via a communication network in response to the client-side user device receiving the change instruction associated with the user preference during output of the first content stream, wherein output of the first content stream is paused at the client-side user device and output of the replacement content item is commenced in response to the client-side user device receiving the change instruction;
a content segment identifying component for identifying, from the sequence of content segments included in the first content stream, a content segment in which the change instruction was received;
a timestamp identifying component for identifying a timestamp associated with a transition point in the first content stream at which the identified content segment transitions to a next content segment in the sequence of content segments; and,
an instruction transmitting component for transmitting a recommencement instruction to the client-side user device configured to instruct the client-side user device as to a point in time in the first content stream at which output of the first content stream is to be recommenced.

16.-17. (canceled)
